(19) United States
(12) Patent Application Publication
(10) Pub. No.: US 2026/0026984 A1
(43) Pub. Date: Jan. 29, 2026

(54) ELECTRIC WHEELCHAIR

(71) Applicant: XSTO CO., LTD., Zhongshan (CN)

(72) Inventors: Zhaoxiang HU, Zhongshan (CN); Yong ZHAO, Zhongshan (CN); Mingyu XU, Zhongshan (CN); Jinwen ZHANG, Zhongshan (CN); Congying LU, Zhongshan (CN)

(21) Appl. No.: 19/342,679

(22) Filed: Sep. 29, 2025

Related U.S. Application Data
(63) Continuation of application No. PCT/CN2024/102052, filed on Jun. 27, 2024.

(30) Foreign Application Priority Data
Jul. 25, 2023 (CN) 202310918345.4

(51) Int. Cl. A61G 5/10; A61G 5/04; A61G 5/06

(52) U.S. Cl. CPC A61G 5/1075; A61G 5/045; A61G 5/068; A61G 5/1059

(57) ABSTRACT

An electric wheelchair, comprising a controller, a seat, front wheels, rear wheels, and a supporting transmission component, which comprises a base bracket, a main supporting frame, a front connecting rod, and a rear driving push rod, the front connecting rod and the rear driving push rod are arranged sequentially in a front-rear direction, an upper end of the main supporting frame is rotatably connected to the seat, a lower end is connected to the front wheels, a front end of the base bracket is rotatably connected to the lower end of the main supporting frame, a rear end is connected to the rear wheels, both ends of the front connecting rod are connected to the seat and the lower end of the main supporting frame, respectively, both ends of the rear driving push rod are rotatably connected to the upper end of the main supporting frame and the base bracket.

### TECHNICAL FIELD

The present application relates to the technical field of mobility devices, and more particularly to an electric wheelchair.

### BACKGROUND

Currently, common electric wheelchairs merely add power to traditional wheelchairs to drive the rear wheels forward and backward, but the problem of instability on uphill and downhill slopes inherent in traditional wheelchairs remains unresolved. When ascending or descending slopes, the seat tilts, causing a shift in the wheelchair's center of gravity, which can easily lead to falls. Existing wheelchairs only allow for raising and lowering from the initial sitting height or below, which fails to meet the needs of users with limited leg mobility to reach high objects.

### SUMMARY

Aimed at resolving at least one of the technical problems existing in the prior art, the present application aims to provide an electric wheelchair that automatically adjusts the center of gravity front and rear according to the slope and maintains a constant seat angle, thereby improving support stability and user safety, allowing users to ascend and descend slopes with the comfort and safety of level ground travel.

To achieve the above objective, the present application provides an electric wheelchair, comprising a controller, a seat, front wheels, rear wheels, and a supporting transmission component;
the supporting transmission component comprises a base bracket, a main supporting frame, a front connecting rod, and a rear driving push rod, wherein the front connecting rod and the rear driving push rod are arranged sequentially in a front-rear direction, an upper end of the main supporting frame is rotatably connected to the seat, and a lower end is connected to the front wheels, a front end of the base bracket is rotatably connected to the lower end of the main supporting frame, and a rear end is connected to the rear wheels, both ends of the front connecting rod are respectively connected to the seat and the lower end of the main supporting frame, while both ends of the rear driving push rod are rotatably connected to the upper end of the main supporting frame and the base bracket;
the seat is provided with an angle sensor, and the controller is electrically connected to the angle sensor, the front connecting rod, and the rear driving push rod.

In a preferred embodiment, the seat comprises a transmission base and a seat cushion, the transmission base is fixed to the rear of the seat cushion, the front connecting rod is rotatably connected to a front end of the transmission base, the upper end of the main supporting frame is rotatably connected to a rear end of the transmission base, and the angle sensor is fixed to either the transmission base or the seat cushion.

In a preferred embodiment, the rear wheel comprises a walking drive component and a rear wheel body, the walking drive component is drivingly connected to the rear wheel, and the rear wheel body is rotatably connected to the base bracket.

In a preferred embodiment, the base bracket comprises lower side connecting rods and a supporting linkage, wherein the number of the lower connecting robs is at least two, the supporting linkage is connected between the two lower side connecting rods, the front ends of the two lower side connecting rods are rotatably connected to the two sides of the main supporting frame, and the lower end of the rear driving push rod and the rear wheels are rotatably connected to the supporting linkage.

In a preferred embodiment, the supporting linkage comprises a middle connecting rod and a rear connecting rod; the rear wheels are rotatably connected to the rear connecting rod, the rear ends of the two lower side connecting rods are fixedly connected to opposite ends of the rear connecting rod in the width direction, the middle connecting rod is located in front of the rear connecting rod and connected between the two lower side connecting rods, and the lower end of the rear driving push rod is rotatably connected to the middle connecting rod.

In a preferred embodiment, the rear wheel comprises an upper supporting bracket, a lower base plate, a rear wheel body, and a buffer component. One end of the lower base plate is rotatably connected to the rear connecting rod, and the other end is connected to the rear wheel body and the lower end of the buffer component. The upper end of the buffer component is connected to the upper supporting bracket, which is connected to the rear end of the lower side connecting rod.

In a preferred embodiment, the lower side connecting rod comprises a gentle section and an inclined section, wherein the front end of the gentle section is connected to a lower end of the inclined section, and an upper end of the inclined section is connected to the lower end of the main supporting frame.

In a preferred embodiment, the main supporting frame comprises an upper end rod, a lower end rod, and main side rods, the upper end rod and the lower end rod extend in a width direction and are each connected to the main side rod at their respective ends, wherein the upper end rod, the lower end rod, and the main side rods are connected to each other, forming a closed frame structure, the upper end of the rear driving push rod is rotatably connected to the upper end rod; the lower end of the front connecting rod is rotatably connected to the lower end rod, and the front end of the lower side connecting rod is rotatably connected to the main side rods.

In a preferred embodiment, the front wheel comprises a front wheel body and a pedal, wherein the two ends of the pedal in a width direction are rotatably connected to the front wheel body, and the rear end of the pedal is connected to the main supporting frame.

In a preferred embodiment, the front wheel body is an omnidirectional wheel.

In a preferred embodiment, the supporting transmission component comprises a level ground walking state, an uphill state, and a downhill state, when the supporting transmission component transitions from the level ground walking state to the uphill state, the rear driving push rod extends, when the supporting transmission component transitions from the level ground walking state to the downhill state, the rear driving push rod shortens.

In a preferred embodiment, the supporting transmission component comprises a lifting state and a folded state; when the supporting transmission component is in the lifting state, the rear driving push rod and the front connecting rod extend, respectively, when the supporting transmission component transitions from the level ground walking state to the folded state, the rear driving push rod and the front connecting rod retract, respectively.

One embodiment of the electric wheelchair according to the present application, compared with the prior art, has the beneficial effect that: the user sits on the seat; the front wheels rotatably connected to the rear end of the base bracket; and the rear wheels are rotatably connected to the front end of the main supporting frame, thereby meeting the wheelchair's locomotion requirements. The supporting transmission component supports the seat and adjusts its angle and height. When the seat tilts on an incline or decline, the angle sensor, connected to the seat, obtains the seat's angle change information and transmits it to the controller. The controller then controls the extension and retraction of the front connecting rod and/or the rear driving push rod in coordination to adjust the seat's angle and height. Specifically, the supporting transmission component comprises a base bracket, a main supporting frame, front connecting rods, and rear driving push rods. The lower end of the front connecting rod is rotatably connected to the lower end of the main supporting frame, and the upper end of the front connecting rod is rotatably connected to the seat. The upper end of the main supporting frame is rotatably connected to the seat. The upper end of the front connecting rod is positioned forward of the upper end of the main supporting frame. The front connecting rod, the seat, and the main supporting frame constitute an inverted triangle support structure. The front end of the base bracket is rotatably connected to the lower end of the main supporting frame. The upper end of the rear driving push rod is rotatably connected to the upper end of the main supporting frame, and the lower end of the rear driving push rod is rotatably connected to the base bracket. The lower end of the rear driving push rod is positioned behind the lower end of the main supporting frame. The rear driving push rod, the main supporting frame, and the base bracket form a triangular support structure. When moving on level ground, the seat is simultaneously supported by the inverted triangle support structure and the triangular support structure, forming a double triangle structure for enhanced structural stability. When ascending a slope, the controller extends the rear driving push rod to provide angle compensation, shifting the seat forward to adjust the center of gravity and maintain a parallel or near-parallel orientation with the ground, while the length of the front connecting rod remains constant. When descending a slope, the controller retracts the rear driving push rod to provide angle compensation, shifting the seat backward to adjust the center of gravity and maintain a parallel or near-parallel orientation with the ground, while the length of the front connecting rod remains constant. During uphill or downhill movement of the seat, the length of the rear driving push rod is adjusted to achieve angle compensation for the seat. Only the triangular support structure changes, while the inverted triangle support structure remains unchanged, ensuring the support stability of the seat during angle compensation. Therefore, the supporting transmission component forms a double triangle structure, achieving angle compensation for the seat during uphill and downhill movement and ensuring the support stability of the seat.

### BRIEF DESCRIPTION OF THE DRAWINGS

FIG. 1 is a schematic diagram of the overall structure of an embodiment of the present application.

FIG. 2 is a rear view of the overall structure of an embodiment of the present application.

FIG. 3 is a front view illustrating the overall structure of an embodiment of the present application.

FIG. 4 is a schematic diagram illustrating the connection structure between the supporting transmission component and the transmission base in an embodiment of the present application.

FIG. 5 is a schematic diagram illustrating the structure of the main supporting frame in an embodiment of the present application.

FIG. 6 is a schematic diagram illustrating the structure of the base bracket in an embodiment of the present application.

FIG. 7 is a schematic diagram illustrating the structure of the rear wheel in an embodiment of the present application.

FIG. 8 is a schematic diagram illustrating the overall structure in the uphill state in an embodiment of the present application.

FIG. 9 is a schematic diagram illustrating the overall structure in the downhill state in an embodiment of the present application.

FIG. 10 is a schematic diagram illustrating the overall structure in the lifting state in an embodiment of the present application.

FIG. 11 is a schematic diagram of the overall structure of the embodiment of the present application in the folded state.

In the figure:
10, Seat; 11, Angle sensor; 12, Transmission base; 13, Seat cushion;
20, Front wheel; 21, Front wheel body; 22, Pedal;
30, Rear wheel; 31, Walking drive component; 32, Rear wheel body; 33, Upper supporting bracket; 34, Lower base plate; 35, Buffer component;
40, Supporting transmission component; 41, Base bracket; 42, Lower side connecting rod; 421, Gentle section; 422, Inclined section; 43, Middle connecting rod; 44, Rear connecting rod; 45, Main supporting frame; 46, Upper end rod; 47, Lower end rod; 48, Main side rod; 49, Front connecting rod; 50, Rear driving push rod; 51, Supporting linkage.

### DETAILED DESCRIPTION

The specific embodiments of the present application will be further described in detail below with reference to the accompanying drawings. The following examples illustrate the present application but do not limit its scope.

In describing the present application, it should be understood that directional or positional relationships indicated by terms such as “up,” “down,” “front,” “rear,” “left,” “right,” “vertical,” “horizontal,” “top,” “bottom,” “inner,” and “outer” are based on the orientations or positions shown in the drawings. These terms are used only to facilitate and simplify the description of the present application and do not indicate or imply that the device or element referred to must have a specific orientation or be constructed and operated in a specific orientation and therefore should not be construed as limiting the present application.

In the description of the present application, it should be understood that terms such as “connected,” “connecting,” and “fixed” should be interpreted broadly. For example, the connection can be fixed, detachable, or integral; it can be a mechanical connection or a welded connection. The connection can be direct or indirect through an intermediate medium. It can also refer to internal communication between two elements or the interaction between them, unless explicitly defined otherwise. Those of ordinary skill in the art will understand the specific meaning of the above terms in the present application based on the particular context.

It should be noted that the front and rear directions in this case refer to the wheelchair's direction of travel, and the left- and right-hand directions of a user seated in the seat, perpendicular to the wheelchair's direction of travel, define the width direction.

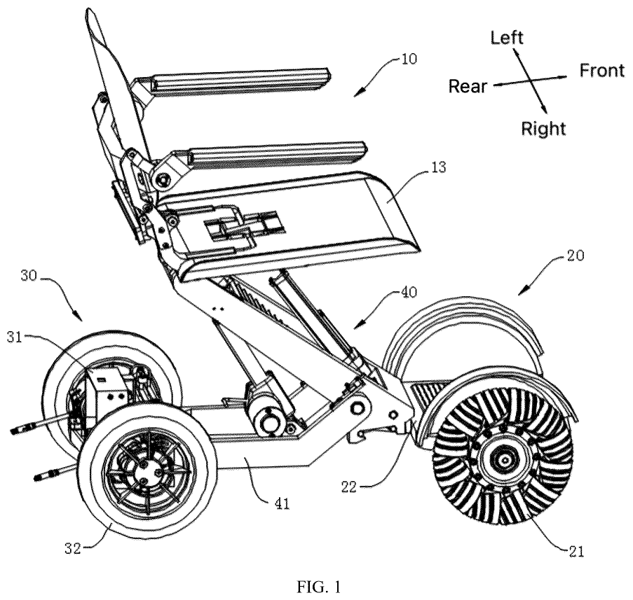

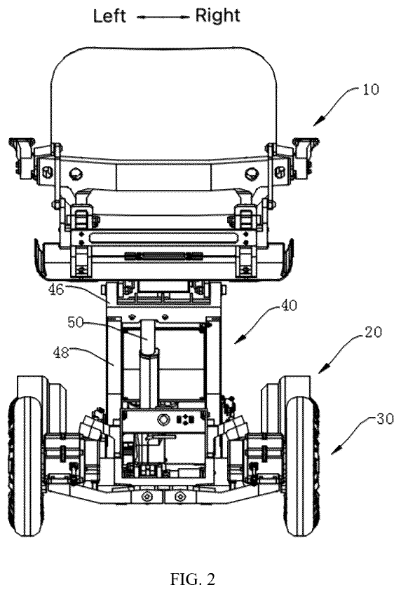

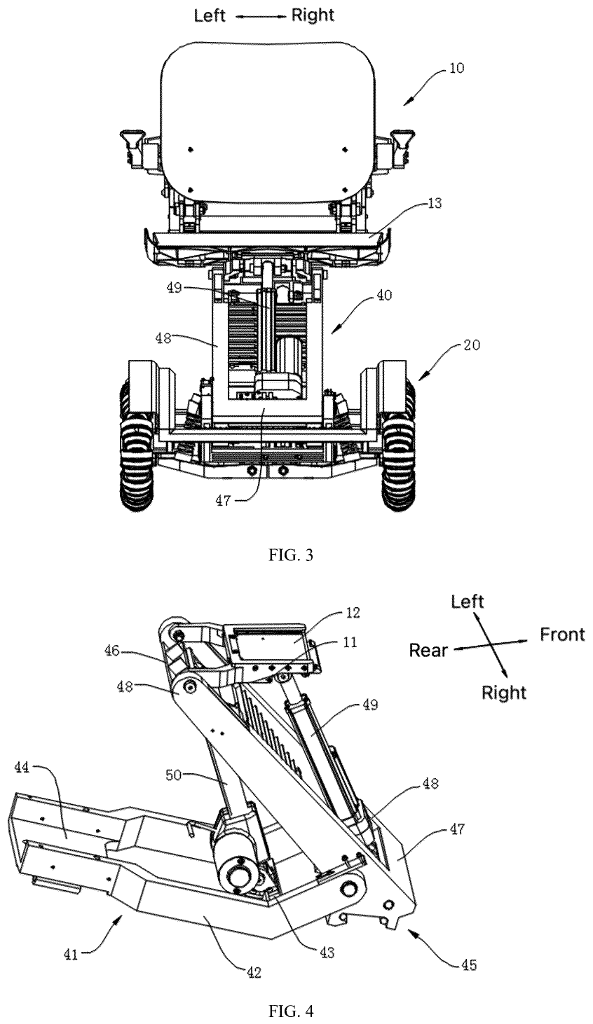

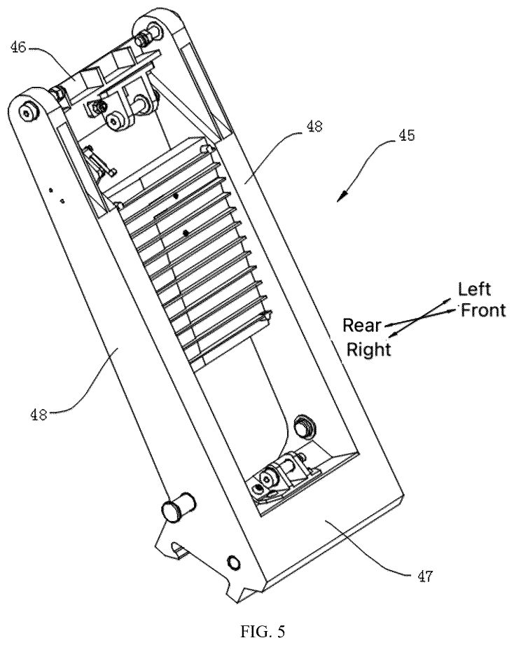

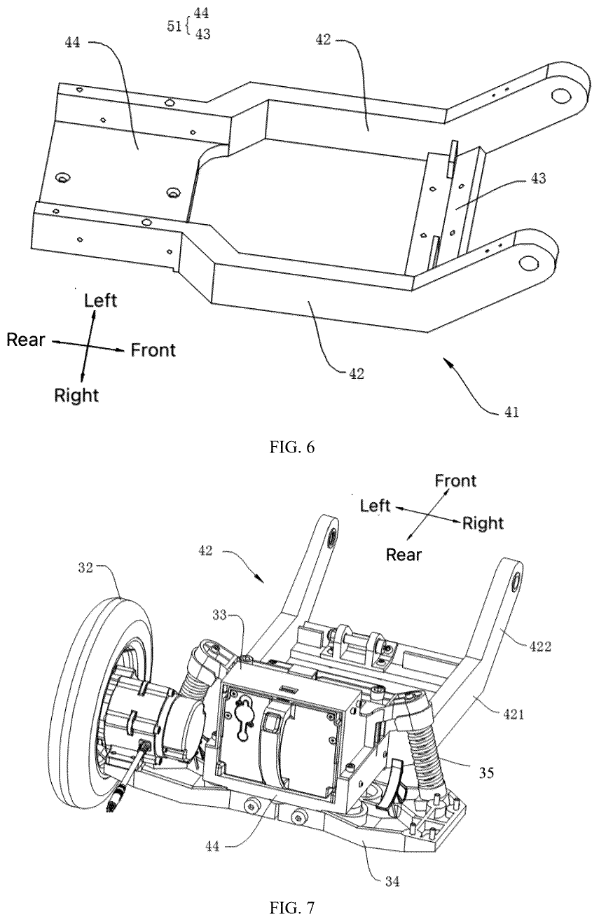

As shown in FIGS. 1 to 10, a preferred embodiment of the electric wheelchair of the present application comprises a controller, a seat 10, front wheels 20, rear wheels 30, and a supporting transmission component 40.

The Supporting transmission component 40 comprises a base bracket 41, a main supporting frame 45, a front connecting rod 49, and a rear driving push rod 50. The front connecting rod 49 and the rear driving push rod 50 are arranged sequentially in the front-rear direction. The upper end of the main supporting frame 45 is rotatably connected to the seat 10, and the lower end is connected to the front wheel 20. The front end of the base bracket 41 is rotatably connected to the lower end of the main supporting frame 45, and the rear end is connected to the rear wheel 30. The two ends of the front connecting rod 49 are connected to the seat 10 and the lower end of the main supporting frame 45, respectively, and the two ends of the rear driving push rod 50 are rotatably connected to the upper end of the main supporting frame 45 and the base bracket 41, respectively.

The seat 10 is provided with an angle sensor 11, and the controller is electrically connected to the angle sensor 11, the front connecting rod 49, and the rear driving push rod 50.

In the electric wheelchair of the present application, the user sits on the seat 10. The front wheel 20 is rotatably connected to the rear end of the base bracket 41, and the rear wheel 30 is rotatably connected to the front end of the main supporting frame 45, enabling the wheelchair to move. The supporting transmission component 40 supports the seat 10 and adjusts its angle and height. When the seat 10 tilts uphill or downhill, the angle sensor 11, connected to the seat 10, obtains angle change information and sends it to the controller. The controller then controls the extension and retraction of the front connecting rod 49 and/or the rear driving push rod 50 to adjust the seat's angle and height. Specifically, the supporting transmission component 40 comprises a base bracket 41, a main supporting frame 45, a front connecting rod 49, and a rear driving push rod 50. The lower end of the front connecting rod 49 is rotatably connected to the lower end of the main supporting frame 45; the upper end of the front connecting rod 49 is rotatably connected to the seat 10; and the upper end of the main supporting frame 45 is rotatably connected to the seat 10. As shown in FIG. 4, the upper end of the front connecting rod 49 is located in front of the upper end of the main supporting frame 45, and the front connecting rod 49, the seat 10, and the main supporting frame 45 form an inverted triangle support structure. The front end of the base bracket 41 is rotatably connected to the lower end of the main supporting frame 45; the upper end of the rear driving push rod 50 is rotatably connected to the upper end of the main supporting frame 45; and the lower end of the rear driving push rod 50 is rotatably connected to the base bracket 41. As shown in FIG. 4, the lower end of the rear driving push rod 50 is located behind the lower end of the main supporting frame 45, and the rear driving push rod 50, the main supporting frame 45, and the base bracket 41 form a triangular support structure. When traveling on a level surface, the Seat 10 is simultaneously supported by both the inverted triangle support structure and the triangular support structure, forming a double triangle structure, which results in strong structural stability. When the seat 10 is ascending a slope, the controller extends the rear driving push rod 50 to provide angle compensation to the seat 10, causing it to move forward and adjust its center of gravity position, maintaining a parallel or substantially parallel orientation to the ground, while the length of the Front connecting rod 49 remains constant. When the seat 10 is descending a slope, the controller retracts the rear driving push rod 50 to provide angle compensation to the seat 10, causing it to move backward and maintain a parallel or substantially parallel orientation to the ground, while the length of the front connecting rod 49 remains constant. During uphill or downhill movement of the seat 10, the length of the rear driving push rod 50 is adjusted to achieve angle compensation for the seat 10. Only the triangular support structure changes, while the inverted triangle support structure remains constant to ensure the support stability of the seat 10 during angle compensation. Therefore, as shown in FIGS. 1 through 4, the supporting transmission component 40 forms a double triangle structure, achieving angle compensation for the seat 10 during uphill and downhill movement and ensuring the support stability of the seat 10.

In one embodiment, the total length of the front connecting rod 49 remains unchanged, simplifying the overall structure of the supporting transmission component 40 and reducing production costs.

In one embodiment, as shown in FIG. 1 and FIG. 4, the main supporting frame 45, front connecting rod 49, and rear driving push rod 50 are each inclined rearward. Given that the front connecting rod 49 and rear driving push rod 50 are of the same model, the range of motion of the supporting transmission component 40 can be increased in both the front and rear direction and the height direction. This increases both the compensation range for the seat's 10 angle and the seat's 10 lifting height, meeting the requirements for use on steeper slopes and for reaching higher objects.

Furthermore, as shown in FIGS. 1 to 3, the seat 10 comprises a transmission base 12 and a seat cushion 13. The transmission base 12 is fixed to the rear of the seat cushion 13. The front connecting rod 49 is rotatably connected to the front end of the transmission base 12, and the upper end of the main supporting frame 45 is rotatably connected to the rear end of the transmission base 12. The angle sensor 11 is fixed to either the transmission base 12 or the seat cushion 13. Seat cushion 13 is fixedly connected to transmission base 12, and angle sensor 11 is fixed to either seat cushion 13 or transmission base 12, maintaining a constant relative position between angle sensor 11 and seat cushion 13. Front connecting rod 49 is rotatably connected to the front end of transmission base 12, and main supporting frame 45 is rotatably connected to the rear end of transmission base 12. The transmission base 12 provides mounting space for the front drive rod and main supporting frame 45. Together, the transmission base 12, main supporting frame 45, and front connecting rod 49 form an inverted triangle support structure. Transmission base 12 is fixed to the rear of seat cushion 13, biasing the seat cushion's center of gravity towards the rear of the wheelchair and improving the stability of the seat 10 during movement.

Further, as shown in FIGS. 1 to 3, the rear wheel 30 comprises a walking drive component 31 and a rear wheel body 32. The walking drive component 31 is drivingly connected to the rear wheel 30, and the rear wheel body 32 is rotatably connected to the base bracket 41. The walking drive component 31 is drivingly connected to the rear wheel body 32. The walking drive component 31 drives the rear wheel body 32 to rotate. In this embodiment, the rear wheel bodies 32 function as drive wheels, and the front wheel bodies 21 function as passive wheels. The front wheels 20 are driven by the rear wheels 30 to roll forward. The main supporting frame 45, the front connecting rod 49, and the rear driving push rod 50 are inclined rearward, shifting the center of gravity of the seat 10 towards the rear. This reduces the load on the front wheel 20, decreasing the friction between the front wheels 20 and the ground, thereby reducing resistance during steering, improving the wheelchair's control efficiency and user experience. Furthermore, when the walking drive component 31 propels the front wheel bodies 21 forward, the rear driving force makes the front wheels more likely to climb upwards upon impact, thereby enhancing the wheelchair's ability to overcome obstacles.

In one embodiment, as shown in FIGS. 1 to 3, rear wheels 30 are rotatably connected to both sides of the base bracket 41, enhancing the wheelchair's walking stability.

Furthermore, as shown in FIGS. 4 to 6, the base bracket 41 comprises a lower side connecting rod 42 and a supporting linkage 51. There are at least two lower side connecting rods 42, and the supporting linkage 51 connects the two lower side connecting rods 42. The front ends of the two lower side connecting rods 42 are rotatably connected to both sides of the main supporting frame 45, and the lower end of the rear driving push rod 50 and the rear wheel 30 are rotatably connected to the supporting linkage 51. The front ends of the two lower side connecting rods 42 are rotatably connected to both sides of the lower end of the main supporting frame 45, and the supporting linkage 51 connects the two lower side connecting rods 42, forming a bottom frame structure. The lower end of the rear driving push rod 50 is connected to the supporting linkage 51, and the upper end of the rear driving push rod 50 is connected to the upper end of the main supporting frame 45. The rear driving push rod 50 and the supporting linkage 51 form a T-shaped support structure for the main supporting frame 45, and the rear driving push rod 50, the lower side connecting rod 42, and the main supporting frame 45 form a triangular support structure, thereby enhancing the overall structural stability of the wheelchair.

Further, as shown in FIGS. 4 to 6, the supporting linkage 51 comprises a middle connecting rod 43 and a rear connecting rod 44 extending in the width direction. The rear wheel 30 is rotatably connected to the rear connecting rod 44. The rear ends of the two lower side connecting rods 42 are fixedly connected to the two ends of the rear connecting rod 44 in the width direction. The middle connecting rod 43 is located in front of the rear connecting rod 44 and connected between the two lower side connecting rods 42. The lower end of the rear driving push rod 50 is rotatably connected to the middle connecting rod 43. The middle connecting rod 43 and the rear connecting rod 44 are respectively connected between the two lower side connecting rods 42 to form a bottom frame structure. The lower end of the rear driving push rod 50 is rotatably connected to the middle connecting rod 43, which is located in front of the rear connecting rod 44. The rear driving push rod 50 and the middle connecting rod 43 form a rearwardly inclined T-shaped structure. Given the same model of the rear driving push rod 50, the range of motion of the main supporting frame 45 can be increased in both the front-rear and height directions, thereby increasing both the angle compensation range of the seat 10 and its lifting height and accommodating steeper slopes and a greater reach. Simultaneously, the rear wheel 30 is rotatably connected to the rear connecting rod 44. Because the rear wheels 30 generate a vertical force when traversing obstacles, it reduces the vertical force acting on the T-shaped support structure formed by the rear driving push rod 50 and the middle connecting rod 43, thereby improving the support stability of the T-shaped support structure.

Further, as shown in FIG. 7, the rear wheel 30 comprises an upper supporting bracket 33, a lower base plate 34, a rear wheel body 32, and a buffer component 35. One end of the lower base plate 34 is rotatably connected to the rear connecting rod 44, allowing rotation around a front and rear direction. The other end of the lower base plate 34 is connected to both the rear wheel body 32 and the lower end of the buffer component 35. The upper end of the buffer component 35 is connected to the upper supporting bracket 33, which is in turn connected to the rear end of the lower side connecting rod 42. The supporting transmission component 40 provides support for the seat 10, and it allows for a greater range of movement in both the front and rear and height directions. The main supporting frame 45, front connecting rod 49, and rear driving push rod 50 are each inclined rearward, shifting the seat's 10 center of gravity toward the rear end of the base bracket 41. This causes the rear end of the base bracket 41 to bear a greater supporting force. Because the rear wheel 30 is connected to the rear end of the base bracket 41, changes in the height of the rear wheel 30 when traversing obstacles exert a vertical force on the rear end of the base bracket 41, making it prone to deformation. The upper supporting bracket 33 is fixed to the rear end of the lower side connecting rod 42, one end of the lower base plate 34 is rotatably connected to the rear connecting rod 44 about the front-rear direction, the rear wheel body 32 is connected to the lower base plate 34, providing the rear wheel 30 with greater freedom of rotation angle in the front-rear direction and a greater activity space in the height direction, enhancing the obstacle-crossing ability of the rear wheel body 32. Meanwhile, the lower base plate 34 and the upper supporting bracket 33 are connected via a buffer component 35, reducing the force exerted by the rear wheel 30 on the rear connecting rod 44 and the lower side connecting rod 42 in the height direction, preventing deformation of the rear connecting rod 44 in the width direction and the lower side connecting rod 42 in the height direction, thereby improving the support stability of the base bracket 41. The buffer component 35 is an existing technical structure used for buffering.

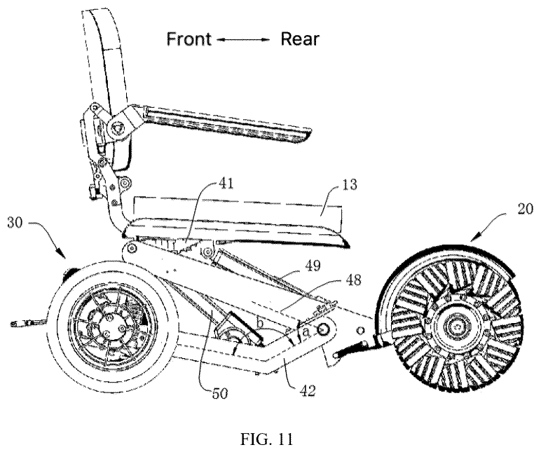

Furthermore, as shown in FIG. 7, the lower side connecting rod 42 comprises a gentle section 421 and an inclined section 422. The front end of the gentle section 421 is connected to the lower end of the inclined section 422, and the upper end of the inclined section 422 is connected to the lower end of the main supporting frame 45. Connected to the lower end of the main supporting frame 45 via the inclined section 422, a portion of the force from the lower end of the main supporting frame 45 is transmitted along the inclined section to the gentle section 421, dispersing the force. The front wheel 20 is connected to the lower end of the main supporting frame 45, preventing stress concentration and potential fracture at the connection point between the main supporting frame 45 and the front wheel 20. Specifically, the rear end of the gentle section 421 connects to one end of the rear connecting rod 44 in the width direction. In one embodiment, as shown in FIG. 11, the inclined section 422 forms an angle a with the main supporting frame 45, where angle a is between 50° and 107°. In one embodiment, as shown in FIG. 11, the inclined section 422 forms an angle b with the gentle section 421, where angle b is between 138° and 144°.

In one embodiment, as shown in FIG. 4, the middle connecting rod 43 connects to the lower side connecting rod 42, forming a connection point. The length a from the connection point to the front end of the lower side connecting rod 42 satisfies the condition: ⅕ of the total length of the lower side connecting rod 42≤a≤⅓ of the total length of the lower side connecting rod 42. The middle connecting rod 43 is positioned towards the front end of the lower side connecting rod 42, causing the rear driving push rod 50 to incline backward. The distance between the middle connecting rod 43 and the main supporting frame 45 in the front and rear direction is shortened, so that the bottom support force of the wheelchair is more concentrated and the support stability of the wheelchair base during movement is improved.

Furthermore, as shown in FIGS. 4 to 6, the main supporting frame 45 comprises an upper end rod 46, a lower end rod 47, and a main side rod 48. The upper end rod 46 and the lower end rod 47 extend laterally, and the main side rods 48 are respectively connected to both ends of the upper end rod 46 and the lower end rod 47. The upper end rod 46, the lower end rod 47, and the two main side rods 48 are interconnected, forming a closed frame structure. The upper end of the rear driving push rod 50 is rotatably connected to the upper end rod 46, the lower end of the front connecting rod 49 is rotatably connected to the lower end rod 47, and the front end of the lower side connecting rod 42 is rotatably connected to the main side rod 48. The upper end rod 46, the lower end rod 47, and the two main side rods 48 are connected to form a frame structure in the height direction, enhancing the support strength of the seat 10 vertically. Based on this frame structure, the lower end of the front connecting rod 49 is rotatably connected to the lower end rod 47, forming a T-shaped support structure laterally, which improves the support stability of the seat 10 laterally. The T-shaped support structure, combined with the inverted triangular structure formed by the front connecting rod 49, the main supporting frame 45, and the seat 10, enhances the support stability of the front end of the wheelchair.

Furthermore, as shown in FIG. 1, the front wheel 20 comprises a front wheel body 21 and a pedal 22. The pedal 22 is rotatably connected to the front wheel body 21 at both ends in the width direction, and the rear end of the pedal 22 is connected to the main supporting frame. In one embodiment, the rear end of the pedal 22 is connected to the lower end rod 47. The pedal 22 provides a foot placement position for the user, and the front wheel bodies 21 are rotatably connected to the pedal 22 on both sides in the width direction, enhancing the walking stability of the front wheel 20. Wherein, the rear end of the pedal 22 is fixedly connected to the lower end rod 47, forming a single unit, which improves the integral connection between the supporting transmission component 40 and the front wheel 20, resulting in a more compact overall structure.

Furthermore, as shown in FIG. 1, the front wheel bodies 21 are an omnidirectional wheel. This facilitates lateral movement when the wheelchair turns sideways. Simultaneously, only a small driving force is required for lateral turning, resulting in more flexible control.

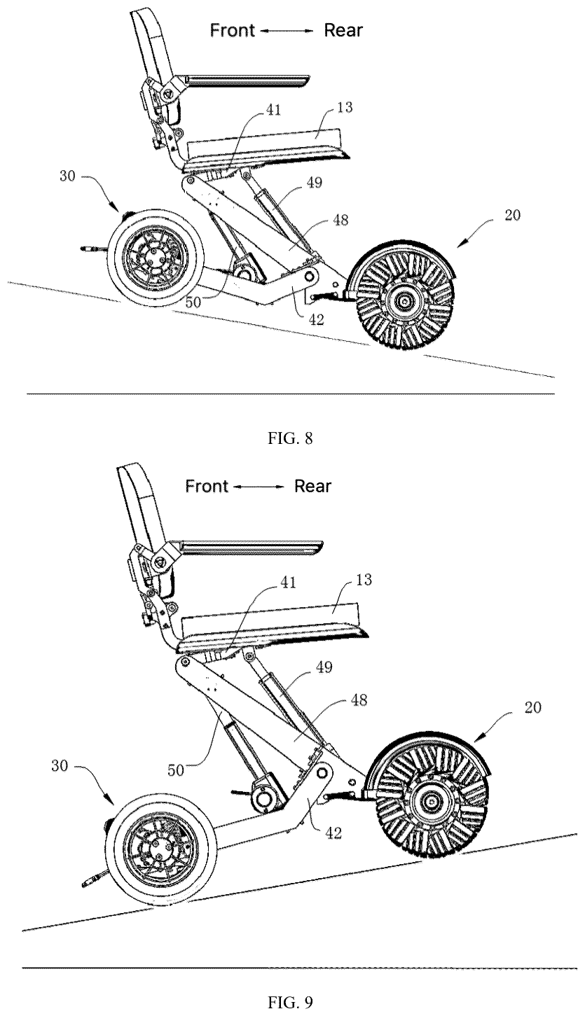

Furthermore, as shown in FIGS. 8 and 9, the supporting transmission component 40 operates in a level ground walking state, an uphill state, and a downhill state. When the supporting transmission component 40 transitions from the level ground walking state to the uphill state, the rear driving push rod 50 extends. When the supporting transmission component 40 transitions from the level ground walking state to the downhill state, the rear driving push rod 50 retracts. In both the uphill and downhill states, adjusting the extension of the rear driving push rod 50 adjusts the support height of the main supporting frame 45 relative to the seat 10. This compensates for the seat's angle, allowing the seat 10 to remain parallel or substantially parallel to the horizontal plane. This adjustment structure is simple and cost-effective to produce. It should be noted that the uphill state refers to the electric wheelchair moving upwards relative to the horizontal direction, including, but not limited to, continuous or discontinuous inclines, such as climbing steps. The downhill state refers to the electric wheelchair moving downwards relative to the horizontal direction, including, but not limited to, continuous or discontinuous declines, such as descending steps. The horizontal direction is perpendicular to Earth's gravity.

Furthermore, the front connecting rod 49 is a telescopic driving push rod, meaning that the distance between the two ends of the front connecting rod can extend or retract, allowing the length of the front connecting rod to be adjusted according to actual needs. The front connecting rod 49 and the rear driving push rod 50 extend simultaneously to lift the seat 10, meeting the user's need to reach high objects. The wheelchair can be folded by simultaneously shortening the front connecting rod 49 and the rear driving push rod 50, thus satisfying storage needs.

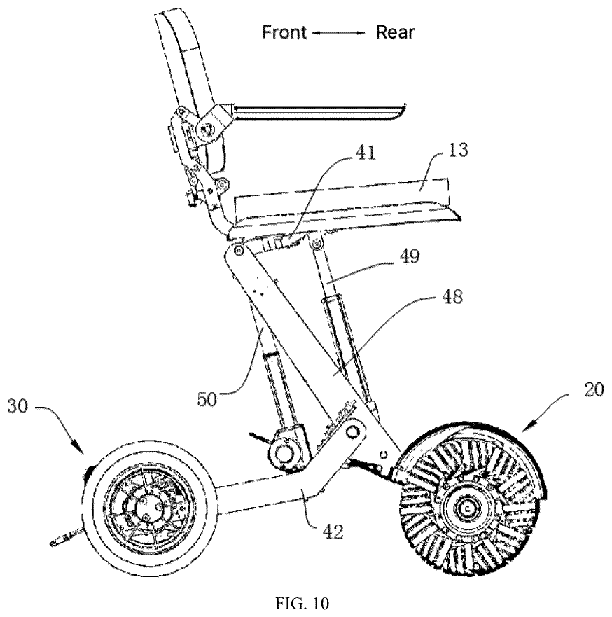

Further, as shown in FIGS. 10 and 11, the supporting transmission component 40 operates in a lifting state and a folded state. When the supporting transmission component 40 transitions from a level ground walking state to the lifting state, the rear driving push rod 50 and the front connecting rod 49 extend, respectively. When the supporting transmission component 40 transitions from a level ground walking state to the folded state, the rear driving push rod 50 and the front connecting rod 49 shorten, respectively. The supporting transmission component 40 enables adjustment for uphill and downhill states, as well as lifting and folded states, thereby accommodating a wider range of user needs.

In summary, the present application provides an electric wheelchair. A user sits on the seat 10, the front wheel 20 is rotatably connected to the rear end of the base bracket 41, and the rear wheel 30 is rotatably connected to the front end of the main supporting frame 45, thus enabling the wheelchair to move. The supporting transmission component 40 supports the seat 10 and adjusts its angle and height. When the seat 10 tilts uphill or downhill, the angle sensor 11, connected to the seat 10, obtains angle change information and sends it to the controller. The controller then controls the extension and retraction of the front connecting rod 49 and/or the rear driving push rod 50 to adjust the seat's angle and height. Specifically, the supporting transmission component 40 comprises a base bracket 41, a main supporting frame 45, a front connecting rod 49, and a rear driving push rod 50. The lower end of the front connecting rod 49 is rotatably connected to the lower end of the main supporting frame 45, the upper end of the front connecting rod 49 is rotatably connected to the seat 10, and the upper end of the main supporting frame 45 is rotatably connected to the seat 10. The upper end of the front connecting rod 49 is located in front of the upper end of the main supporting frame 45, forming an inverted triangle support structure with the front connecting rod 49, the seat 10, and the main supporting frame 45. The front end of the base bracket 41 is rotatably connected to the lower end of the main supporting frame 45, the upper end of the rear driving push rod 50 is rotatably connected to the upper end of the main supporting frame 45, and the lower end of the rear driving push rod 50 is rotatably connected to the base bracket 41. The lower end of the rear driving push rod 50 is located behind the lower end of the main supporting frame 45, forming a triangular support structure with the rear driving push rod 50, the main supporting frame 45, and the base bracket 41. When traveling on a level surface, the seat 10 is simultaneously supported by both the inverted triangle support structure and the triangular support structure, forming a double triangle structure, which results in strong structural stability. When the seat 10 is ascending a slope, the Controller extends the rear driving push rod 50 to provide angle compensation to the seat 10, causing it to move forward and adjust its center of gravity position, maintaining a parallel or substantially parallel orientation to the ground, while the length of the front connecting rod 49 remains constant. When the seat 10 is descending a slope, the controller retracts the rear driving push rod 50 to provide angle compensation to the seat 10, causing it to move backward and maintain a parallel or substantially parallel orientation to the ground, while the length of the front connecting rod 49 remains constant. During uphill or downhill movement of the seat 10, the length of the rear driving push rod 50 is adjusted to achieve angle compensation for the seat 10. Only the triangular support structure changes, while the inverted triangle support structure remains constant to ensure the support stability of the seat 10 during angle compensation. Therefore, the supporting transmission component 40 forms a double triangle structure, achieving angle compensation for the seat 10 during uphill and downhill movement, and ensuring the support stability of the seat 10. The front connecting rod 49 and the rear driving push rod 50 extend simultaneously to lift the seat 10, meeting the user's need to reach high objects. The wheelchair can be folded by simultaneously shortening the front connecting rod 49 and the rear driving push rod 50, thus satisfying storage needs.

The above are merely preferred embodiments of the present application. It should be noted that those skilled in the art can make several improvements and substitutions without departing from the technical principles of the present application, and these improvements and substitutions should also be considered within the protection scope of the present application.

What is claimed is:

1. An electric wheelchair, comprising a controller, a seat, front wheels, rear wheels, and a supporting transmission component;
the supporting transmission component comprises a base bracket, a main supporting frame, a front connecting rod, and a rear driving push rod, wherein the front connecting rod and the rear driving push rod are arranged sequentially in a front-rear direction, an upper end of the main supporting frame is rotatably connected to the seat, and a lower end is connected to the front wheels, a front end of the base bracket is rotatably connected to the lower end of the main supporting frame, and a rear end is connected to the rear wheels, both ends of the front connecting rod are respectively connected to the seat and the lower end of the main supporting frame, while both ends of the rear driving push rod are rotatably connected to the upper end of the main supporting frame and the base bracket;
the seat is provided with an angle sensor, and the controller is electrically connected to the angle sensor, the front connecting rod, and the rear driving push rod.

2. The electric wheelchair according to claim 1, wherein the seat comprises a transmission base and a seat cushion, the transmission base is fixed to the rear of the seat cushion, the front connecting rod is rotatably connected to a front end of the transmission base, the upper end of the main supporting frame is rotatably connected to a rear end of the transmission base, and the angle sensor is fixed to either the transmission base or the seat cushion.

3. The electric wheelchair according to claim 1, wherein the rear wheel comprises a walking drive component and a rear wheel body, the walking drive component is drivingly connected to the rear wheel, and the rear wheel body is rotatably connected to the base bracket.

4. The electric wheelchair according to claim 1, wherein the base bracket comprises lower side connecting rods and a supporting linkage, wherein the number of the lower connecting robs is at least two, the supporting linkage is connected between the two lower side connecting rods, the front ends of the two lower side connecting rods are rotatably connected to the two sides of the main supporting frame, and the lower end of the rear driving push rod and the rear wheels are rotatably connected to the supporting linkage.

5. The electric wheelchair according to claim 4, wherein the supporting linkage comprises a middle connecting rod and a rear connecting rod; the rear wheels are rotatably connected to the rear connecting rod, the rear ends of the two lower side connecting rods are fixedly connected to opposite ends of the rear connecting rod in the width direction, the middle connecting rod is located in front of the rear connecting rod and connected between the two lower side connecting rods, and the lower end of the rear driving push rod is rotatably connected to the middle connecting rod.

6. The electric wheelchair according to claim 5, wherein the rear wheel comprises an upper supporting bracket, a lower base plate, a rear wheel body, and a buffer component, one end of the lower base plate is rotatably connected to the rear connecting rod about the front-rear direction, the other end of the lower base plate is connected to the rear wheel body and a lower end of the buffer component, respectively, an upper end of the buffer component is connected to the upper supporting bracket and the upper supporting bracket is connected to the rear end of the lower side connecting rod.

7. The electric wheelchair according to claim 4, wherein the lower side connecting rod comprises a gentle section and an inclined section, wherein the front end of the gentle section is connected to a lower end of the inclined section, and an upper end of the inclined section is connected to the lower end of the main supporting frame.

8. The electric wheelchair according to claim 4, wherein the main supporting frame comprises an upper end rod, a lower end rod, and main side rods, the upper end rod and the lower end rod extend in a width direction and are each connected to the main side rod at their respective ends, wherein the upper end rod, the lower end rod, and the main side rods are connected to each other, forming a closed frame structure, the upper end of the rear driving push rod is rotatably connected to the upper end rod;
the lower end of the front connecting rod is rotatably connected to the lower end rod, and the front end of the lower side connecting rod is rotatably connected to the main side rods.

9. The electric wheelchair according to claim 1, wherein the front wheel comprises a front wheel body and a pedal, wherein the two ends of the pedal in a width direction are rotatably connected to the front wheel body, and the rear end of the pedal is connected to the main supporting frame.

10. The electric wheelchair according to claim 1, wherein the supporting transmission component comprises a level ground walking state, an uphill state, and a downhill state, when the supporting transmission component transitions from the level ground walking state to the uphill state, the rear driving push rod extends, when the supporting transmission component transitions from the level ground walking state to the downhill state, the rear driving push rod shortens.

11. The electric wheelchair according to claim 10, wherein the front connecting rod is a telescopic driving push rod.

12. The electric wheelchair according to claim 11, wherein the supporting transmission component comprises a lifting state and a folded state; when the supporting transmission component is in the lifting state, the rear driving push rod and the front connecting rod extend, respectively, when the supporting transmission component transitions from the level ground walking state to the folded state, the rear driving push rod and the front connecting rod retract, respectively.
